(19) United States
(12) Patent Application Publication
(10) Pub. No.: US 2026/0312456 A1
(43) Pub. Date: Oct. 8, 2026

(54) ELECTRIC MOTOR WITH IMPROVED ASSEMBLY

(71) Applicant: Moving Magnet Technologies, Besancon (FR)

(72) Inventors: Valentin Préault, Osselle (FR); Antoine Foucaut, Montarlot les Rioz (FR)

(21) Appl. No.: 19/491,446

(22) PCT Filed: Jun. 7, 2024
(86) PCT No.: PCT/EP2024/065756

§ 371 Date: Dec. 9, 2025

(30) Foreign Application Priority Data
Jun. 9, 2023 (FR) FR2305861

(51) Int. Cl. H02K 5/10; H02K 11/33; H02K 15/32

(52) U.S. Cl. CPC H02K 5/10; H02K 11/33; H02K 15/32; H02K 2211/03

(57) ABSTRACT

An electric motor includes a rotor and a stator, the stator comprising a plurality of coils that are interconnected with an electronic board in a sealed area, the electronic board being housed in a compartment that is separated both from the coils of the stator and from the rotor by a transverse partition or a transverse part. The coils are mounted on an annular stator support. The stator support or the transverse part has a front annular partition, which separates a first space in which the coils are located, and a second space formed by a sealed chamber in which the inter-coil connections are located. The pairs of wires of the coils pass radially through the front annular partition.

### CROSS-REFERENCE TO RELATED APPLICATIONS

This application is a national phase entry under 35 U.S.C. § 371 of International Patent Application PCT/EP2024/065756, filed Jun. 7, 2024, designating the United States of America and published as International Patent Publication WO 2024/251958 A1 on Dec. 12, 2024, which claims the benefit under Article 8 of the Patent Cooperation Treaty of French Patent Application Serial No. FR2305861, filed Jun. 9, 2023.

### TECHNICAL FIELD

The present disclosure relates to the field of electric motors and, in particular, to electric fan motors.

For certain applications where the motor may be exposed to an aggressive environment containing moisture and/or particles, it is necessary to protect electrical connections and bare live parts in a sealed space. With the advent of high-voltage power, particularly in the automotive sector, where standard supply voltages can be as high as 400 volts or even 800 volts, this issue is becoming particularly important, as the presence of moisture or conductive particles can lead to the formation of electric arcs, causing serious damage to electrical connections, or even local destruction or fire hazards.

For this reason, it has been proposed in the prior art to separate the space containing the motor components, i.e. the magnetized rotor and stator coils, and a sealed space housing the electronic components, printed electronic boards and electrical connections. Various solutions have been proposed to ensure the watertightness of this connection area.

### BACKGROUND

The prior art includes International Patent Application Publication WO2003081755, which relates to a stator for an electric motor, in particular, a high-power low-voltage motor of the external-armature type, comprising a stack of stator laminations provided with a plurality of stator grooves and stator teeth for accommodating stator windings, and an interconnection system for interconnecting the winding wires of the stator windings. The stator windings wound around the stator teeth through the stator grooves overhang the stack of stator laminations of a coil head on both end faces. The interconnection system consists of winding contact elements as well as interconnection contact elements, at least the interconnection contact elements being located on an end face of the stator laminate stack substantially within a space bounded by the stator windings and by a plane defined by the coil head.

U.S. Patent Application Publication No. US2012098363 describes an electric motor stator with phase potential bars and an insulating retaining element. The insulating retaining element comprises a first component configured to accommodate the phase potential bars and to electrically isolate the phase potential bars from each other. The insulating retaining element further comprises a second component separate from the first. The second component, in combination with the first component, forms a bowl that borders the phase potential bars.

The prior art solutions are not entirely satisfactory, as they involve either sealing the entire motor assembly, thus posing a problem for coil cooling, or placing only the electronic board in a sealed compartment, thus sealing the rigid, discrete conductors connecting it to the winding phases. The prior art solutions involve placing the connections in a separate sealed enclosure.

These sealing means are provided axially, which complicates the manufacturing process, as the output wire of the spool is floating, i.e. with a free end, which must be “pushed” through a seal, an operation that is difficult to carry out industrially at high production rates. The discrete solutions of the prior art are not satisfactory at industrial scale, because of the proliferation of manual tasks.

Furthermore, the disclosure proposes a proliferation of passages between the two spaces, and therefore the risk of loss of sealing in the event that one of the seals were to degrade.

### BRIEF SUMMARY

The object of the present disclosure is to overcome these drawbacks by combining radial connections that lead into a watertight chamber with a separate chamber containing a printed electronic board.

Thus, the present disclosure relates to an electric motor.

This motor has a rotor and a stator comprising a plurality of coils that are interconnected with an electronic board in a sealed area, the electronic board being housed in a compartment that is separated both from the coils of the stator on the one hand and from the rotor on the other by a transverse partition or transverse part, characterized in that
the coils are mounted on an annular stator support,
the stator support or transverse part has a front annular partition,
the front annular partition separating a first space housing the coils, and a second space formed by a sealed chamber housing the inter-coil connections,
the front annular partition being radially traversed by the wire pairs of the coils.

In a particular embodiment, the front annular partition is an extension of the stator support, and is closed by a transverse partition to form the chamber.

In addition, the annular partition is associated with a deformable seal to provide radial sealing of the wire pairs.

In particular, the annular partition has two rings defining between them an annular groove in which the deformable seal is housed, the rings being provided with slots for the wires to pass through.

In one variant, the deformable seal is a toroidal part having a lower part formed by two coaxial lips, straddling the peripheral ring, one of the lips being inserted in the annular groove.

More particularly, the toroidal part is also provided with indentation slots lining the flanks of the slots of the ring, the indentation slots being narrower than the wires to force the toroidal part to deform when the wires are inserted.

Even more particularly, the bottom of the slots of the ring has a projection to form a stop when the wires are inserted axially through the slots.

In one variant, at least one complementary annular seal is associated with the deformable seal to close the passage of the wires.

In particular, the rotor is housed within the stator.

In this case, the stator support produces coil bodies by overmolding the stator teeth.

In particular, the coils are produced by winding the wires directly onto the coil bodies of the stator support.

In addition, the magnetic body of the stator is formed by the assembly of the teeth with a stator yoke, all of which is held together by the stator support.

Alternatively, the stator is housed inside the rotor.

The disclosure also relates to a method for manufacturing an electric motor incorporating one or a combination of the above features, in which all the coils are made sequentially and without interruption of the wire between two coils.

### BRIEF DESCRIPTION OF THE DRAWINGS

The present disclosure will be better understood from reading the following description, which relates to a non-limiting exemplary embodiment illustrated by the accompanying drawings, in which:

FIG. 1 shows an exploded view of an exemplary embodiment of a motor according to the disclosure,

FIG. 2 shows a detailed perspective view of the wound stator of the motor,

FIG. 3 shows a detailed perspective view of the coil support overlaying the teeth of the stator,

FIG. 4 shows a cross-sectional perspective view of the coil support overlaying the teeth of the stator,

FIG. 5 shows a perspective view of the stator before the ring is assembled,

FIG. 6 shows a cross-sectional view of the motor,

FIG. 7 shows a detailed perspective view of the passage of the coil wires,

FIG. 8 shows another detailed perspective view of the passage of the coil wires,

FIG. 9 shows a perspective cross-sectional view of the rotor assembly,

FIG. 10 shows a detailed view of the rotor assembly, showing the mounting of a bearing in the rotor end shield,

FIG. 11 shows a cross-sectional view of a motor according to the disclosure and its impeller,

FIG. 12 shows a view of a variant of the electrical circuit without lugs for soldering the coil wires onto,

FIG. 13 shows a schematic view of another variant with an external rotor,

FIG. 14 shows a schematic view of another variant with a housing for the electronic board integrated into the stator.

### DETAILED DESCRIPTION

The example described relates to an electric motor used for forced ventilation functions and, in particular, to electronically commutated polyphase motors with the drive control integrated into the motor housing and the coils exposed to the air flow to enable optimum cooling, while at the same time protecting the connector portions and the electronic control device in a sealed manner, so as to avoid short circuits during immersion, if necessary.

The solution provided by the present disclosure is particularly attractive for the construction of high-power ventilation motors (over 1 kW) used to cool the components of electric vehicle fast-charging devices, but it can also be used for any type of ventilation drive motor or pump with integrated electronics, enabling the fluid flow to be used to cool the stator coils located in the space exposed to the airflow, without any risk of contaminating the sealed areas from the external environment. It is also possible to create a sealed area that encompasses the rotor for enhanced protection by taking advantage of the stator overlay, adding a part that closes this cavity and can also serve as a rotor guide.

A particular feature of the disclosure is the design of the sealing zone at the level of the insulated winding wires, so as to ensure that no bare zone can be exposed to splashes or seepage of water when the motor is submerged. The windings can then be exposed to the air flow to evacuate the heat generated by the motor's iron and copper losses, without risking a short-circuit.

It should be noted that the two sealed spaces, the one containing the connector portions and the one containing the electronic control device, can have passages from one to the other through the housing wall, as this does not call into question the protection of all the sensitive elements located inside either of these spaces.

### Detailed Description of An Example with An Internal Rotor

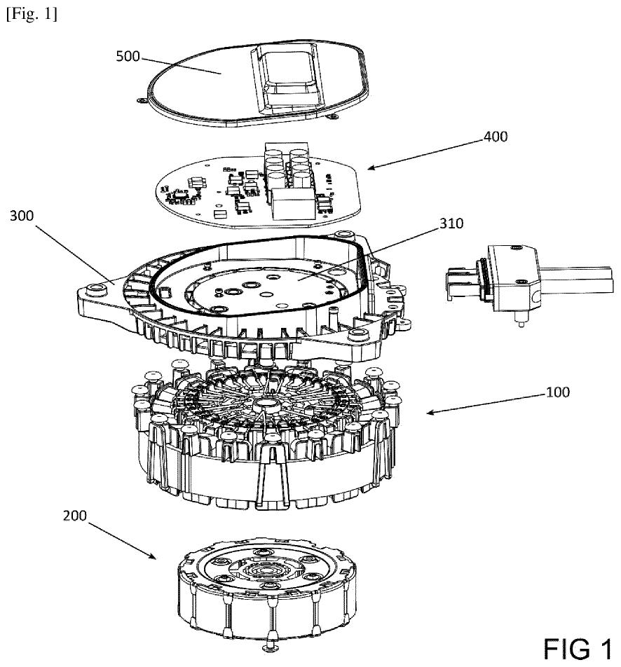

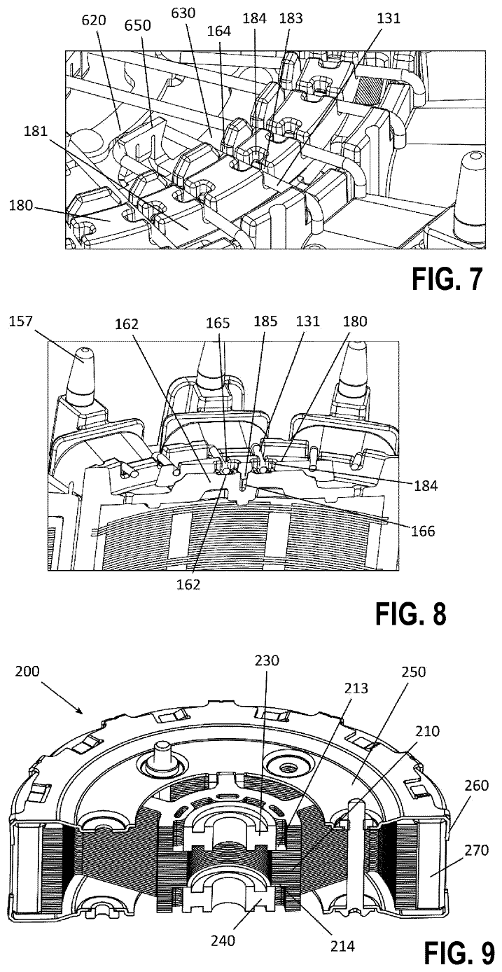

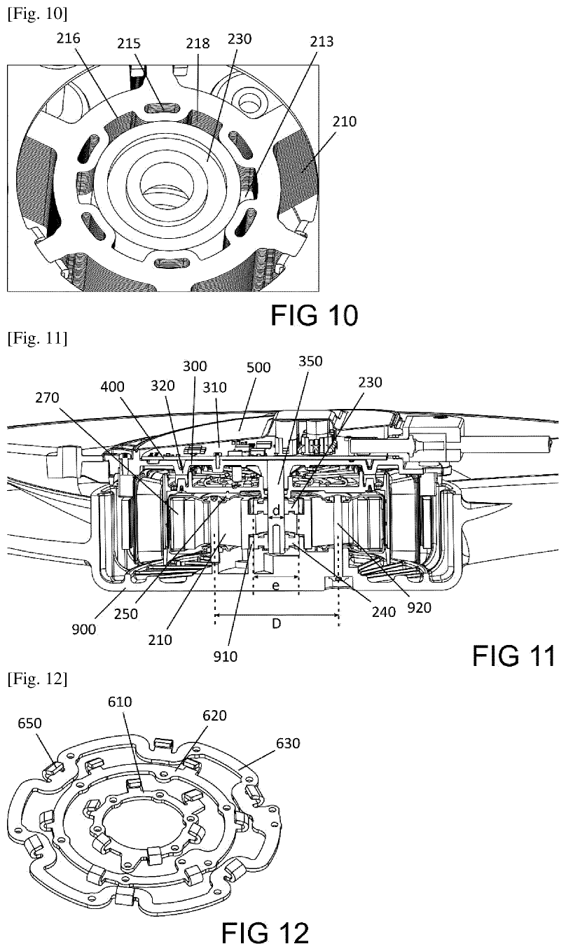

FIGS. 1 to 10 illustrate a non-limiting example described in detail below.

FIG. 1 shows an exploded view of the motor, without its impeller. It is made up of:
a rotor (200),
a stator (100),
a transverse part (300), for example, a metal part, particularly made of aluminum,
a printed electronic circuit board (400),
a closure cover (500).

### Detailed Description of the Stator (100)

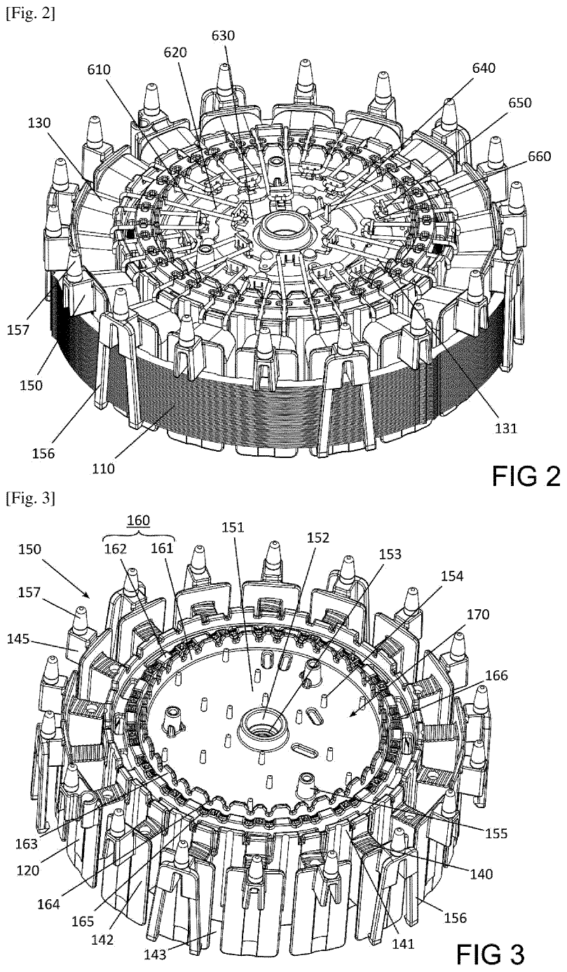

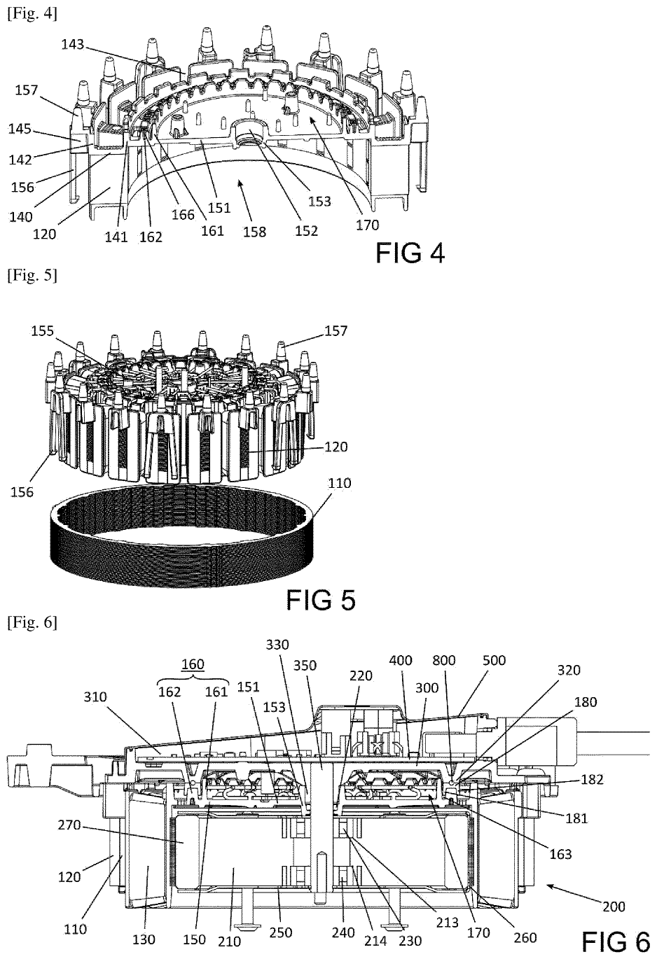

FIGS. 2 and 5 show a detailed view of the stator (100). It consists of a stator support (150), more particularly shown in FIGS. 3 and 4, and a stator yoke (110) formed by a stack of laminations, each with an annular cut-out, with FIG. 5 showing the stator before assembly of the stator yoke (110) on the stator support (150).

The stator support (150) is overlaid, by injection molding of a plastic material, with a set of radial teeth (120) also formed by one, or possibly a plurality of, stacks of laminations. This overlaying creates spaces, called coil bodies (140), for the winding that generates the magnetic field interacting with the rotor (200). The coil bodies (140) extend radially from an annular casing (141), the inner surface of which is coplanar with the front of the teeth (120) and which extends axially on both sides of the teeth over the desired coil height so as to provide a front support zone for the coil wires (130). In its inner part, the annular casing (141) defines a rotor-accommodating cavity (158) visible in FIG. 4. The coil bodies extend radially along the teeth (120) with a minimum thickness to maximize the space for the coils (130), while ensuring electrical insulation between the coils (130) and the stake of laminations of the teeth (120). The coil bodies (140) are extended at their outer end by an annular sector (142), adjoining the outer surface of the teeth (120), and of the same axial extent as the annular casing (141) so as to provide distal support for the coil wires (130). The peripheral annular sectors (142) are not contiguous between the teeth (120), but leave a free angular sector (143) to facilitate the travel of the needle during the winding operation. In an advantageous configuration, visible in FIG. 3, these coil bodies (140) are ribbed to guide the wires and facilitate winding, which is particularly useful when winding large cross-section wires with high rigidity.

The annular sectors (142) of the coil bodies (140) are radially extended at the top by “U”-shaped protrusions (145) whose legs extend in the direction of the teeth. Some of these protrusions (145) are provided with flexible extensions (156) extending axially beyond the opposite end of the teeth, these flexible extensions (156) being terminated by hooks so as to ensure that the stator yoke is held by clips once it has been assembled to the stator support (150).

As shown in FIG. 5, the stator yoke (110) is inserted axially, so that the outer surface of the teeth (120) comes into mechanical and magnetic contact with the inner surface of the stator yoke (110) to ensure magnetic flux closure. The stator yoke is then held in position by the flexible extensions (156).

In a direction opposite to that in which the flexible extensions (156) extend, some or all of the protrusions (145) have a protuberance (157) that ensures the connection with the transverse part (300) by way of heat-staking.

As shown in FIGS. 3 and 4, the stator support (150) has an inner core closed by a transverse partition (151) with an axial passage (152) running through it. This axial passage (152) is crossed by a central shaft (350) designed to guide the rotor (200). A housing (153) is provided to receive a toroidal seal (220) of the “O Ring™” type to seal the upper part. The central shaft is fixedly mounted in a guide nose (330) of the transverse part (300), this guide nose (330) being inserted into the axial passage (152) when the transverse part (300) is assembled on the stator support (150).

The upper surface of the transverse partition (151) features protuberances (154) constituting plastic rivets for fastening the inter-coil connection tracks (610, 620, 630) by way of heat-staking, as described below. Protuberances (155) with a threaded hole are designed to receive screws for fastening the transverse part (300).

The transverse partition (151) is surrounded at its periphery by a front annular partition (160) extending perpendicularly to its surface to form a sealed chamber (170) in which the inter-coil bonds and the stripped areas of the wires are enclosed, while the wire outside this chamber (170) is always insulated and continuous.

### Detailed Description of the Annular Partition (160)

The front annular partition (160) acts as a sealing passage for wire pairs extending radially from the coils (130) into the sealed chamber (170). In the general case, each coil has a pair of wires running through the front annular partition (160). In special cases, two or more coils are connected in series by a continuous, non-stripped wire, and in this case, the connecting wire between the coils does not need to pass back through the sealed chamber (170), so the radially extending pair of wires will correspond to all the coils in series. This is all the more true if the coils connected in series are adjacent, but the skilled person could also find ways of connecting a set of non-adjacent coils in series using a continuous wire, while ensuring routing compatibility with the assemblies of other phases.

In a preferred embodiment, and as described in this example, the teeth are wound by a single continuous wire, running successively through the coils and forming loops inside the chamber (170), where the wire surrounds interconnecting support posts (650). However, it is also possible to provide independent, separately wound coils, inserted radially on the teeth of the support, with the wires arranged radially through the front annular partition (160).

FIG. 3 shows a detailed view of a non-limiting example of the front annular partition (160). It features two concentric rings (161, 162) defining an annular groove (163). The rings (161, 162) are indented by radial slots (164, 165) respectively to allow the wires (131) of the coils (130) to pass through radially and to guide them when winding the stator support (150). The top of the peripheral ring (162) has anchoring recesses (166) for engaging hooks (185) for positioning and hooking a deformable, indented toroidal part (180), for example, made of elastomer.

This toroidal part (180) has a lower part formed by two coaxial lips (181, 182), straddling the peripheral ring (162), the lip (182) fitting into the annular groove (163), and an indented upper part through which the radial wires of the coils (130) pass locally, the width of the indentation slots (183) being less than the cross-section of the winding wire (131) to ensure tight pinching of the wire.

This toroidal part (180) has a cavity (184) on both sides of each indentation slot (183), which opens onto the adjacent slot (183) to enable filling with an adhesive or resin to provide a seal after the winding wires (131) have been inserted.

These indentation slots (183) match the side walls of the slots (165) in the peripheral ring (162).

The bottoms of the slots (165) of the peripheral ring (162) each have a projection (167) of the same width as the cavities (184) to form a support for the winding wire (131) and prevent it from causing shearing of the bottom of the toroidal part (180) during winding and a potential loss of sealing of the front annular partition (160).

When the wires are all in place, the chamber (170) is perfectly sealed by an additional seal (800), for example, made by depositing glue or silicone, placed between the periphery of the front annular partition (160) and the transverse part (300). The annular configuration of the toroidal part (180) means that the seal (800) can be deposited on its entire upper face in a single continuous dose, ensuring a perfect seal while limiting production costs.

The transverse part (300) has an annular protrusion (320) with a shape complementary to that of the front annular partition (160), or the toroidal part (180) covering it, to provide a sealed peripheral barrier for the chamber (170).

This is an advantageous example, but it is understood that other solutions for sealing the wire passage (131) are also possible. For example, the annular groove (163) between the rings (161, 162) could be filled with a deposit of glue or silicone that could be forced into the slots (164, 165) by a piston effect during assembly with the transverse part (300) thanks to a shape complementary to the gap and located on the transverse part. However, this second solution would be more costly, as it would require a much larger deposit of glue, a material with a reputation for being expensive. Alternatively, a resin or silicone ring could be deposited on the stripped area of the wires (131), or the peripheral ring could not be positioned above the surface of the stator support, but could be a front annular partition formed on the lower surface of the transverse part (300).

### Closing the Sealed Space

In the example described, the electronic circuit board (400) is housed in a sealed chamber (310) separate from the chamber (170), with the two chambers communicating with each other. In one variant, a single chamber (170) is provided, with sufficient volume to house both the coil interconnection and the electronic circuit board (400).

A closure cover (500) seals the chamber (310).

### Detailed Description of the Coil Interconnection

In the example described, the motor has three phases, resulting in interconnection of the coils for grouping via an electrical circuit (600) formed by three metal tracks (610, 620, 630).

As can be seen in FIG. 2, the wire (131) alternates between the coils (130) and the electrical circuit (600) during automatic winding, without breaking the wire.

The wire (131) is anchored at a starting point (640) formed by a flared shape in which the beginning of the wire is engaged and held by wedging. It then passes radially through the front annular partition (160) successively through slots (164, 165) provided in the rings (161, 162), and then coils around a first tooth (120), before radially rejoining the chamber (170) by passing again successively through further slots (165, 164) in the front annular partition (160). Inside the chamber (170), it bypasses a support post (650) of a first track (610), before returning radially towards another coil (130) adjacent to the previous one, after passing through the front annular partition (160) via yet further slots (164, 165).

The wire (131) then coils around the second tooth, before returning radially to the chamber (170), again passing through slots (165, 164) in the front annular partition (160). Inside the chamber (170), it bypasses a support post (650) of a second track (620), before returning radially towards another coil (130) adjacent to the previous one; and so on.

Each support post (650) is associated with a deformable lug (660) that, after the wire (131) has passed through, is folded back against the wire (131) surrounding the support post (650) to provide a soldering point where the wire's insulation coating is locally removed. The support posts (650) and lugs (660) are created by local deformations of the metal track (610, 620, 630).

In the most general case, the wire (131) passes through the front annular partition (160) before and after each coil (130). However, in the case where certain coils (130) are connected in series, whether consecutive or not, the wire (131) passes through the front annular partition (160) only to ensure connections between a coil and a track (610, 620, 630), but not for direct connections of two coils (130), in order to reduce passages and therefore possible sources of leakage.

### Detailed Description of the Rotor (200)

In the example described, the rotor is guided by two ball bearings (230, 240) inserted in the rotor yoke (210), which consists of a stack of laminations, spaced axially apart to ensure stability. The outer rings of the ball bearings (230, 240) are both mounted clamped in the rotor yoke (210) forming the yoke of the rotor. Note that in FIGS. 1, 4 and 10, the laminations are not depicted, for the sake of legibility. The inner races of the ball bearings (230, 240) are slidably mounted on the central shaft (350).

The rotor yoke (210) has recessed zones (215) for the laminations located at the bearings (230, 240), with a non-circular central cut-out (216) to ensure radial elasticity for insertion of the outer race of the bearing by press-fitting and elastic deformation of the housing of the bearing. The other laminations have a simple circular central cut-out, with an internal diameter smaller than the outer diameter, e, of the outer races of the bearings (230, 240), but greater than the diameter d of the central shaft (350), so as to form an axial stop (213, 214) for the bearings (230, 240).

The central shaft (350) is fixed and integral with the transverse part (300), into which it is force-fitted or overlaid, or secured by any other known means.

In this way, the rotor (200) is easily inserted into the stator (100), since the two bearings (230, 240) integral with the rotor slide on the fixed central shaft (350) planted in the transverse part (300).

The guide provided by the central shaft (350) enables magnetic radial forces between the rotor (200) and the stator (100) to be taken up, without impeding assembly.

The final height of the rotor (200) plus stator (100) assembly is optimized, as it is then possible to fix the impeller, not shown, directly into the rotor yoke (210) formed from a stack of laminations via flanges (250) fitted with claws (260) for holding the magnets (270), and thus eliminate the lower flange that holds the front bearing of the rotor, as may be the case with solutions known from the prior art.

### Mounting The Impeller

FIG. 11 shows a cross-section of the motor fitted with the impeller (900).

The impeller (900) is not driven by the central guide shaft (350) of the rotor, but by a direct connection to the rotor yoke (210).

The fastening points of the impeller (900) on the rotor yoke (210), which must enable the drive torque to be transmitted, can be freely positioned on a diameter that can be larger than the diameter of the central shaft (350), since the only constraint is to remain inscribed within the interior of the rotor yoke (210) or of a flange (250) holding the magnets (270) that can be attached to it. This positioning diameter, D, is of the same order of magnitude as the positioning diameter of the magnets (270) and therefore much larger than the diameter d of the fixed central shaft (350) or bearings, which can be small to reduce their cost.

This makes it possible to transmit high torque (several Newton meters) without exerting high stresses on the mechanical components, thanks to the much larger positioning radius than in the prior-art solutions already mentioned.

In the embodiment shown below, the bearings (230) and (240) are mounted in an “O” configuration, so that the bearings' centers of force are further apart, for greater stability of the rotating assembly.

The use of a cut-out in the inner lamination of the rotor (200), which forms a central shoulder (213, 214) on which the outer races of the two bearings (230, 240) mounted clamped in this housing are axially supported, combined with force take-up by the inner races of the bearings (230, 240) respectively against a conical spring, or an elastic washer, abutting on the axial passage (152) of the transverse cavity (151) on the one hand, and a snap ring mounted at the end of the central shaft (350) on the other, enables a configuration to be achieved that provides the best guidance for a large, highly inertial rotating assembly.

Finally, as the impeller (900) is a large-diameter part that can rotate rapidly, it is necessary to ensure that the masses of this part are well-balanced. To reduce or avoid the balancing process after the impeller is mounted on the motor, it must be centered as closely as possible to the motor's axis of rotation at the time of mounting. In order to optimally position and guide the insertion of the impeller, axial fingers (910) of the impeller can be inserted around the bearing outer race (240), in recessed areas (218) of the stack of laminations of the rotor. This ensures excellent concentricity of the impeller with respect to the axis of rotation of the rotor (200). The axial fingers (910) have a beveled end to facilitate their insertion into the recessed areas (218). The impeller (900) is preferably molded from a single piece in order to maintain precise geometric tolerances between the various surfaces. The impeller (900) is secured to the rotor by way of fixing screws (920).

### Variant of the Electrical Circuit (600)

FIG. 12 shows a variant of the electrical circuit (600) without the lugs (660) for electrically soldering the wires (131) of the coils (130) onto, as shown in FIG. 2. If the arc discharge energy is sufficient, it is simpler to fold back lugs (260) from the tracks (610, 620, 630) to minimize the electrical resistance around the soldering point. This embodiment simplifies the bending operation and can lead to substantial savings by improving the process and reducing cycle time.

### Variant With External Rotor (200)

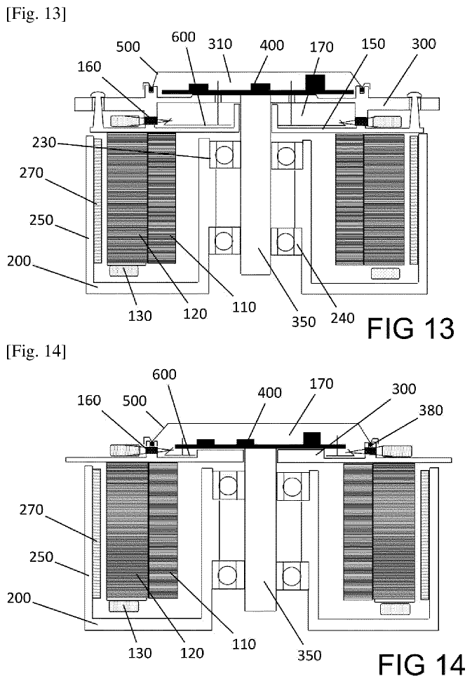

FIG. 13 shows a variant with an external rotor (200). This embodiment differs in that the rotor (200) is not fully housed within the stator, but extends axially from the receiving cavity (158), where it is guided on the central shaft (350) via the bearings (230, 240), to surround the lamination stacks of the stator while forming a bell (250). The magnets (270) of the rotor (200) line the inner cavity of this bell (250) to face the teeth (120). The stator yoke (110) then joins the teeth (120) at their inner end.

### Variant With Single Cavity

FIG. 14 shows one variant of the disclosure. This embodiment differs from previous embodiments in that the electronic circuit board (400) and the electrical circuit (600) are housed in one and the same chamber (170). In this embodiment, the transverse part (300) is an integral part of the stator support (150) and the sealing of the chamber (170) at the front annular partition (160) is ensured by the use of an annular form (380) interposed between the transverse part (300) and the closure cover (500).

Of course, the single sealed cavity design shown in FIG. 14 does not by any means limit the disclosure, and the person skilled in the art could well imagine associating this single cavity with an external rotor configuration, but also that the single cavity be formed between the stator support (150) and the transverse part (300) acting as a cover.

1. An electric motor comprising a rotor and a stator having a plurality of coils that are interconnected with an electronic board in a sealed area, the electronic board being housed in a compartment that is separated from the plurality of coils of the stator and from the rotor by a transverse partition or transverse part, wherein:
the plurality of coils are mounted on an annular stator support;
the annular stator support or transverse part has a front annular partition;
the front annular partition separates a first space housing the plurality of coils, and a second space formed by a sealed chamber housing the inter-coil connections; and
the front annular partition is radially traversed by wire pairs of the plurality of coils.

2. The electric motor of claim 1, wherein the front annular partition is an extension of the annular stator support, and wherein the front annular partition is closed by a transverse partition to form the sealed chamber.

3. The electric motor of claim 1, wherein the front annular partition is associated with a deformable seal to provide radial sealing of the wire pairs.

4. The electric motor of claim 3, wherein the front annular partition has two rings defining between them an annular groove in which the deformable seal is housed, the two rings having wire slots for passage of the wires of the wire pairs.

5. The electric motor of claim 3, wherein the deformable seal is a toroidal part having a lower part formed by two coaxial lips straddling a peripheral ring of the two rings, one of the two coaxial lips being inserted in the annular groove.

6. The electric motor of claim 5, wherein the toroidal part has indentation slots lining flanks of the slots of the peripheral ring, the indentation slots being narrower than the wires of the wire pairs to force the toroidal part to deform when the wires of the wire pairs are inserted.

7. The electric motor of claim 6, wherein bottoms of the wire slots of the peripheral ring has a projection to form a stop during axial insertion of the wires through the wire slots.

8. The electric motor of claim 4, wherein at least one complementary annular seal is associated with the deformable seal to close the passage of the wires of the wire pairs.

9. The electric motor of claim 1, wherein the rotor is housed within the stator.

10. The electric motor of claim 9, wherein the annular stator support produces coil bodies by overlaying teeth of the stator.

11. The electric motor of claim 10, wherein plurality of coils are produced by winding the wires of the wire pairs directly onto said the coil bodies of the annular stator support.

12. The electric motor of claim 11, wherein a magnetic body of the stator comprises an assembly of teeth with a stator yoke the assembly of teeth and the stator yoke being secured by way of the annular stator support.

13. The electric motor of claim 1, wherein the stator is housed inside the rotor.

14. A method for manufacturing an electric motor, the electric motor comprising a rotor and a stator having a plurality of coils that are interconnected with an electronic board in a sealed area, the electronic board being housed in a compartment that is separated from the plurality of coils of the stator and from the rotor by a transverse partition or transverse part, the rotor being housed within the stator, wherein:
the coils of the plurality of coils are mounted on an annular stator support;
the annular stator support or transverse part has a front annular partition;
the front annular partition separates a first space housing the plurality of coils, and a second space formed by a sealed chamber housing the inter-coil connections;
the front annular partition is radially traversed by wire pairs of the plurality of coils;
wherein the annular stator support produces coil bodies by overlaying teeth of the stator;
wherein the plurality of coils are produced by winding the wires of the wire pairs directly onto the coil bodies of the annular stator support;
wherein the method comprises winding the wires of the wire pairs directly onto the coil bodies of the annular stator support, the winding of the wires of the wire pairs to form all the coils being performed sequentially and without interruption of the wires of the wire pairs between two coils.

15. The electric motor of claim 2, wherein the front annular partition is associated with a deformable seal to provide radial sealing of the wire pairs.

16. The electric motor of claim 15, wherein the front annular partition has two rings defining between them an annular groove in which the deformable seal is housed, the two rings having wire slots for passage of the wires of the wire pairs.

17. The electric motor of claim 16, wherein the deformable seal is a toroidal part having a lower part formed by two coaxial lips straddling a peripheral ring of the two rings, one of the two coaxial lips being inserted in the annular groove.

18. The electric motor of claim 17, wherein the toroidal part has indentation slots lining flanks of the slots of the peripheral ring, the indentation slots being narrower than the wires of the wire pairs to force the toroidal part to deform when the wires of the wire pairs are inserted.

19. The electric motor of claim 18, wherein bottoms of the wire slots of the peripheral ring has a projection to form a stop during axial insertion of the wires through the wire slots.

20. The electric motor of claim 19, wherein at least one complementary annular seal is associated with the deformable seal to close the passage of the wires of the wire pairs.
